(19) United States
(12) Patent Application Publication
(10) Pub. No.: US 2026/0044606 A1
(43) Pub. Date: Feb. 12, 2026

(54) METHOD FOR OPERATING A COMPUTING UNIT IN A SAFE OPERATING MODE

(71) Applicant: Robert Bosch GmbH, Stuttgart (DE)

(72) Inventor: Dieter Thoss, Fellbach-Oeffingen (DE)

(21) Appl. No.: 19/150,060

(22) PCT Filed: Apr. 2, 2024
(86) PCT No.: PCT/EP2024/058838

§ 371 Date: Jul. 22, 2025

(30) Foreign Application Priority Data
Apr. 6, 2023 (DE) 10 2023 203 238.4

(51) Int. Cl. G06F 21/57

(52) U.S. Cl. CPC G06F 21/575; G06F 2221/034

(57) ABSTRACT

A method for operating a computing unit in a safe operating mode. The method includes reading an activation instruction for activating a safe operating mode, activating the safe operating mode in response to the activation instruction which has been read; in the safe operating mode, reading instructions and calculating a current check value in each case from a current instruction to be executed and a previous check value; and in the safe operating mode, checking the current check value at least once.

### FIELD

The present invention relates to a method for operating a computing unit in a safe operating mode, and to a computing unit and a computer program for carrying out said method.

### BACKGROUND INFORMATION

In a computing unit, such as a microcontroller or a system-on-a-chip (SoC), a functionally safe execution platform may be implemented (referred to, for example, as “safe island”, “vital modules”, “safe backbone” or “safe execution platform”) to make possible the execution of software at the highest level of safety with respect to operational safety or functional safety. For example, in the automotive sector this level of safety may be ASIL-D, the highest safety integrity level for safety-relevant systems in motor vehicles according to the safety standards of ISO 26262 or the ASILs (automotive safety integrity levels) defined therein.

Such a functionally safe execution platform can be realized, for example, by providing two identical processor cores and operating them in the so-called lockstep method, wherein the two cores execute the same processes and check their results for plausibility against each other and wherein an error signal can be output if deviations are detected. The cores usually have separate clock trees and separate areas on the particular chip. For example, program code may be stored in an embedded NOR flash memory and data may be stored in an embedded static read-only memory.

However, such a lockstep concept with an additional, redundant processor core is associated with high power consumption and high space requirements. Furthermore, the lockstep concept cannot be implemented equally well in all processor types. For example, the lockstep concept may be well-suited for cores of average performance level which are used, for example, for motor control or for controlling brake systems in vehicles. However, at higher performance levels, the lockstep method is often poorly scalable. High-performance cores often can be operated in parallel lockstep operation only to a limited extent. Also, NOR flash memory often cannot scale to nodes below 28 nm and requires more area than NAND flash. Embedded static random-access memory can usually comprise no more than 10 MiB (mebibytes).

Functionally safe execution platforms based on the lockstep principle are therefore often suitable only to a limited extent for systems with large program code and large amounts of data, such as in autonomous driving.

### SUMMARY

According to the present invention, a method for operating a computing unit in a safe operating mode and a computing unit and a computer program for carrying out the method are provided.

Advantageous embodiments of the present invention are disclosed herein.

The present invention allows the computing unit to be operated in the safe operating mode in a safe manner with respect to operational safety or functional safety. The terms “safety” and “safe” in this context are understood to mean, in particular, operational safety or functional safety, as opposed to information technology security or information security.

According to an example embodiment of the present invention, the computing unit comprises in particular: a processor unit having one or more processor cores; a non-volatile memory unit, e.g., a (NAND) flash memory; and a volatile memory unit, e.g., an (LPDDR) random-access memory. The non-volatile memory unit expediently stores software or program code. The software comprises individual instructions or machine instructions or commands which, in particular, were created by a compiler in the course of a compiling process. For execution, the processor unit reads the individual instructions from the volatile memory unit and executes them. In the course of regular operation or a regular operating mode of the computing unit, this reading or fetching of instructions is done in a conventional manner. In the course of the safe operating mode, on the other hand, the reading is done in a special way to make possible the safe operation of the computing unit.

For this purpose, in the method, an activation instruction for activating the safe operating mode is read and executed by the processor unit, in particular during the regular operating mode of the computing unit. In response to this activation instruction which has been read, the safe operating mode of the processor unit is activated. For example, this activation instruction may be implemented using a compiler instruction or a pragma directive.

In the safe operating mode, instructions are read by the processor unit, in particular from the volatile memory unit, in particular in each case in the course of a fetch or instruction fetch, and in each case a current check value is calculated by the processor unit from a current instruction to be executed and from a previous check value, in particular according to a check value calculation scheme pwₙ=f (oₙ, pwₙ₋₁), the check value pwn being a function f of the previous check value pwₙ₋₁ and the current instruction oₙ.

The instructions oₙ which have been read may then be executed by the processor unit. If a previous check value pw₀ does not yet exist at the first call (n=1), for example a predetermined value (e.g., zero) may be used for this purpose, or an initial check value pw₀ may be read together with the activation instruction. Accordingly, the activation instruction may be augmented with the initial check value, for example as an argument of the instruction.

In the safe operating mode, the then-current check value is checked by the processor unit at least once. For example, for this purpose the current check value may be compared with an associated pre-calculated reference check value. To this end, for each instruction of the software the associated reference check value may also be stored in the non-volatile memory unit. Since the chain or series of instructions is known beforehand, the series of check values may also be determined in advance. For example, the current check value may be checked at regular time intervals or when specific events occur.

The safe operating mode allows a functionally safe execution platform (safe island, vital module, safe backbone or safe execution platform) to be implemented in a low-cost, energy-saving and space-saving manner. In the safe operating mode, it may be possible to execute software at a high or highest safety level, for example at the highest safety integrity level ASIL-D according to the safety standards of ISO 26262 in the automotive sector. By means of the check values, the individual instructions read may be expediently checked for correctness and integrity in the safe operating mode, and it may further be assessed whether the individual instructions have been read correctly. If, in the course of checking the check values, an error is detected, a specified action may be performed, for example an error message may be output or an entry may be made in an error memory, or the system may also be stopped or transferred to a safe state if necessary. In the safe operating mode, in particular safe reading of instructions may be made possible, even from an unsafe memory unit, e.g., a conventional (NAND) flash memory or (LPDDR) random-access memory, even via an unsafe communication system, e.g., an internal processor bus system.

According to an example embodiment of the present invention, the individual instructions are expediently each augmented with a reference check value outside the computing unit, for example during the compiling process, and may then be checked in the computing unit by the process core according to this reference check value and the calculated check value in the course of the reading of said individual instructions, e.g., when a specified check event occurs. In this way, in particular the integrity of the instructions can be ensured from the compiler to the processor core.

The method of the present invention is suitable, for example, for all processor units and logic units which process a program and which, to that end, read commands from a memory. In particular, the method is also suitable for high-performance cores as well as for systems with large program code and large amounts of data, which are used, for example, for autonomous driving. In particular, no special hardware units are needed to implement the safe operating mode; for example, conventional memory units and buses may be used. Furthermore, in particular no implementation of error detection methods (error detection code, EDC) or error correction methods (error correcting code, ECC) in hardware is needed. For example, a large external random-access memory may be used and may be connected to the processor unit via a conventional standard interface, e.g., via a JEDEC-LPDDR interface. Furthermore, for example a conventional external NAND flash may be used to write program code and initialization data into random-access memory. The safe operating mode may be expediently activated and deactivated at any time, as needed.

While the program code may require more memory space due to the additional reference check values, the safe operating mode does not require embedded NOR flash memory and embedded static read-only memory. For the safe operating mode, additional logic for the processor core as well as additional instructions and control and status registers (CSRs) may be provided, which may lead to a slightly increased space requirement on the chip, but significantly less space requirement than would be the case for a separately secured memory.

For example, according to an example embodiment of the present invention, the check values may each be calculated according to a cyclic redundancy check (CRC). The length of the individual check values may, for example, be selected such that such a check value can be incorporated into the activation instruction as a direct value. Since the check value calculation is performed with each instruction fetch, which proceeds in particular with a full core clock cycle, the calculation is performed in a single clock cycle, in particular at least in the case of 16- and 32-bit instructions. The check values can expediently also be applied to 64-bit instructions and to longer instructions. The check values cover in particular at least 128 32-bit instructions (4096 program memory bits), e.g., in order not to consume too much program space and run time. In particular, the check value thus may be calculated continuously, but a pre-calculated comparison value may exist only every 128 instructions. A calculation scheme for the check value calculation may expediently be specified such that hardware expense and power consumption for the calculation are as low as possible. Furthermore, the calculation scheme may be specified such that different sequences of the same instructions expediently result in different check values. To satisfy, for example, the ASIL-D safety level, the check values should expediently detect, to at least 99%, any possible combination of bit errors. The so-called Hamming weight, i.e., the number of undetected errors, for any number of bit errors is in particular less than or equal to 1% of the number of possible errors.

According to one example embodiment of the present invention, the (then-) current check value is checked in the safe operating mode when a specified checking event occurs. It may in this way expediently be specified how often or in the case of what particular events the current check value should be checked during the safe operating mode.

According to one example embodiment of the present invention, the specified check event includes reading a specified check instruction. Such a check instruction may be a specific machine instruction for instructing the processor unit to check the current check value. Such a check instruction may expediently be generated at any time as needed or in response to a specific triggering event, e.g., after a specified number of instructions read. In this way it is possible, for example, to adhere to a specified error detection time, and it is possible, for example, to prevent the situation in which too many read, unchecked instructions lead to a reduction in error coverage, i.e., a probability of being able to detect any combination of errors. For example, such check instructions may be generated in the course of the compiling process and expediently placed at a suitable location in the instruction sequence. The check instruction may be augmented with a reference value.

Alternatively or additionally, according to one example embodiment of the present invention, the specified check event includes reading a jump instruction for executing a jump in the program sequence. Such a jump instruction instructs the processor unit to jump to a specific instruction in the program code or to a corresponding memory address and to execute said specific instruction or the instruction located at said memory address. In principle, such a jump may lead anywhere, even to a potentially hazardous target. To prevent this, a check of the current check value may expediently be performed with each jump, wherein in particular the check value calculated from the jump instruction is itself checked.

Alternatively or additionally, according to one example embodiment of the present invention, the specified check event includes reading a subroutine instruction for executing a subroutine. Similarly to a jump instruction, such a subroutine instruction may expediently be used to instruct the processor unit to execute specific instructions of a particular program code module. In particular if this subroutine is large or compiled from a different source file than the rest of the instructions, a check may be performed. For this purpose, a check of the then-current check value may be performed in particular when a subroutine instruction is read.

Alternatively or additionally, the specified check event includes reading a branching instruction for executing multiple branches of instructions. By means of such a branching instruction, the processor unit may be instructed to split a regular, linear program sequence. At the start of each of these instruction branches, a check of the then-current check value may expediently be performed.

According to one example embodiment of the present invention, a specified action is performed if no check of the current check value has been performed after a specified maximum number of instructions read and/or after a specified maximum time interval has elapsed. If no check was performed, for example, after 100 instructions read and/or after a microsecond, for example an error message, e.g., timeout error, may be output as the action.

According to one example embodiment of the present invention, in the safe operating mode, in particular to end the same, a deactivation instruction for deactivating the safe operating mode is read. The current check value is then calculated from this deactivation instruction and the previous check value, and this current check value is checked. Thus, it can be finally determined that the safe operating mode was error-free. In response to reading this deactivation instruction, the safe operating mode can be deactivated by the processor unit and the computing unit can again be operated in the regular operating mode. For example, this deactivation instruction too, similarly to the activation instruction, may be implemented by means of a compiler instruction or pragma directive.

According to one example embodiment of the present invention, after the activation instruction has been read, a first check value is calculated from a first instruction currently to be executed and from a predetermined initial check value or a read initial check value as the previous check value. In the safe operating mode, the current check value is then checked on the basis of this first check value. For example, the check value calculation may be initialized with this initial value such that the check value that is checked at deactivation corresponds, in an error-free case, to a predetermined expected value, e.g., the value of zero. Alternatively, the check value calculation may also be initialized with a specified initial value, e.g., zero, in which case the final value then corresponds, in an error-free case, to a value which can be pre-calculated with knowledge of the chain of instructions.

According to one example embodiment of the present invention, instructions to be read, for example, one or more or all of them, are provided with a reference check value in advance before the safe operating mode is activated. Particularly expediently, these reference check values are created in the executable machine code in the course of a compiling process of program code. For execution, the instructions to be read are expediently loaded, together with the associated reference check value, into the volatile memory unit, from which the individual instructions are read together with the reference check value in the safe operating mode. The check of the current check value calculated, in the course of the safe operating mode, from an instruction read may then be performed according to the reference check value of this instruction, in particular by comparing the corresponding current check value with the reference check value.

According to one example embodiment of the present invention, in the safe operating mode the current check value is modified when a number of instructions are skipped and not executed and/or when a number of instructions already executed are executed again, for example as a result of the execution of a corresponding jump instruction or branching instruction. In such a case, the checking of check values may fail when there is a specified omission or repetition of individual instructions, even though all instructions have been read and executed correctly and as specified. To prevent this, the current check value is modified or altered using a modification instruction. If a number of instructions are not executed in the course of a jump, a first modification instruction is read and executed by the processor unit. By this first modification instruction, for example by an argument of the first modification instruction, the current check value is modified as if the individual skipped instructions had been executed. If, in the course of a loop, a number of already executed instructions are executed again, a second modification instruction is read. By this second modification instruction or by an argument of this instruction, the current check value is modified as if the individual instructions executed again had been executed only once. For example, the particular modification instruction may be created in the course of the compiling process and may be introduced into the instruction sequence at an appropriate location.

According to one example embodiment of the present invention, the computing unit comprises a processor unit based on a RISC-V instruction set architecture (ISA). The term “instruction set” refers in general to all machine instructions that a processor unit can execute. The RISC-V instruction set architecture is based on the so-called RISC (reduced instruction set computer) principle, according to which the instruction set comprises a low number of instructions, typically below 100, which can each be processed by the processor unit easily and quickly, whereby a simplified processor design, a high processor clock speed and a fast execution speed can be achieved, in contrast to the so-called CISC (complex instruction set computing) architecture, which provides an instruction set having a high number of instructions (above 100), by which instructions a particular processor may execute complex processes, but this being associated with a complex processor design. The RISC-V instruction set architecture is an open standard or open source and allows for easy modifications and expansions of the instruction set. RISC-V processors, or in general processors having a modifiable instruction set architecture, are therefore particularly expedient for implementing the safe operating mode, since instructions required for the execution of the safe operating mode, such as the activation, deactivation, check or modification instructions, may be easily integrated into the instruction set.

Particularly preferably, according to an example embodiment of the present invention, the method is suitable for application in the automotive sector. The computing unit may in particular be configured as a microcontroller or control unit in a (motor) vehicle. Processes executed by the computing unit may include, for example, safety-critical functions that are executed to safely operate and control the vehicle, for example in the course of motor control, in the course of driving assistance functions, or also in the course of autonomous driving, etc. Safety or fail-safety and integrity of the control unit may be increased by the present method. In particular, the method may be used to meet safety requirements in the (motor) vehicle sector, which are specified, for example, in the standard ISO 26262 or in particular by the so-called automotive safety integrity level (ASIL), a safety integrity level for safety-relevant systems in motor vehicles which is specified by ISO 26262.

A computing unit according to the present invention, e.g., a control unit of a motor vehicle, is configured, in particular in terms of programming, to perform a method according to the present invention.

The implementation of a method according to the present invention in the form of a computer program or computer program product comprising program code for carrying out all method steps is advantageous as well, because the associated costs are very low, in particular if an executing control unit is also used for other tasks and is therefore already available. Lastly, a machine-readable storage medium is provided, on which the computer program is stored as described above. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can take place in a wired, or cabled, or wireless manner (e.g., via a WLAN, a 3G, 4G, 5G, or 6G connection, etc.).

Further advantages and embodiments of the present invention emerge from the description and the figures herein.

The present invention is shown schematically in the figures on the basis of embodiment examples and is described below with reference to the figures.

### BRIEF DESCRIPTION OF THE DRAWINGS

FIG. 1 schematically shows a design of a computing unit according to the present invention which is configured to carry out an embodiment of a method according to an example embodiment of the present invention.

FIG. 2 schematically shows an example embodiment of a method according to the present invention as a block diagram.

FIG. 3 schematically shows an example embodiment of a method according to the present invention as a block diagram.

FIG. 4 schematically shows an example embodiment of a method according to the present invention as a block diagram.

FIG. 5 schematically shows an example embodiment of a method according to the present invention as a block diagram.

FIGS. 6A and 6B schematically show example embodiments of a method according to the present invention as a block diagram.

FIGS. 7A and 7B schematically show example embodiments of a method according to the present invention as a block diagram.

FIGS. 8A and 8B schematically show example embodiments of a method according to the present invention as a block diagram.

### DETAILED DESCRIPTION OF EXAMPLE EMBODIMENTS

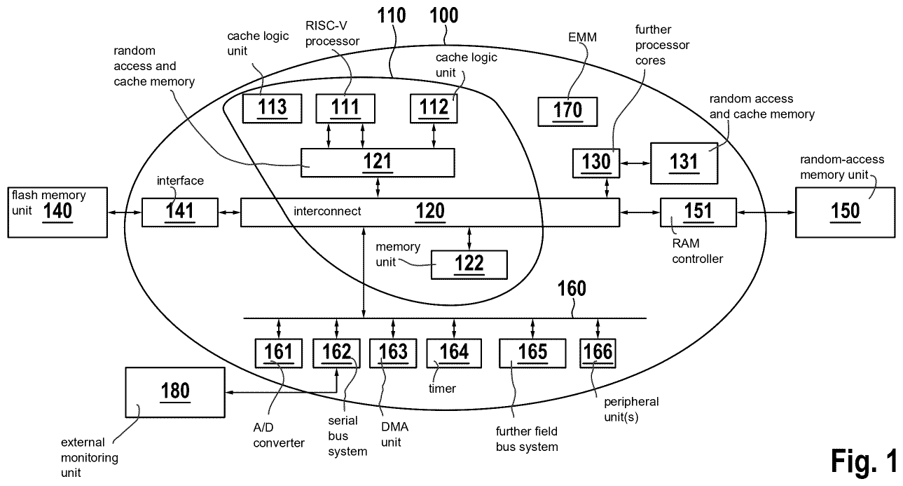

In FIG. 1, a computing unit is shown schematically and denoted by 100; this computing unit may be configured, for example, as a system-on-a-chip (SoC). For example, the SoC 100 may be provided for a motor vehicle and may be integrated into a control unit of the vehicle, for example in order to execute safety-critical functions for the safe operation of the vehicle, e.g., in the course of motor control, in the course of driving assistance functions, in the course of autonomous driving, etc.

In order to ensure the safety and integrity of the control unit, to execute software at the highest safety level and to be able to meet safety requirements of the (motor) vehicle sector, in particular in accordance with the ASIL-D safety integrity level of standard ISO 26262, the SoC 100 is configured, in particular in terms of programming, to carry out an embodiment of a method according to the present invention. In the course of this method, the SoC 100 may be operated in a safe operating mode in which safe fetching of instructions is made possible. In this way, a functionally safe execution platform 110 (safe island, vital modules, safe backbone or safe execution platform) is realized in the SoC 100.

In the example shown, a processor unit 111, a cache logic unit 112, and a timer 113 are provided for this functionally safe execution platform 110 or for the execution of the safe operating mode. The processor unit 111 may expediently (but not necessarily) be a processor core based on a RISC-V instruction set architecture. This RISC-V processor 111 and the cache logic unit 113 are connected, for example via a random-access and cache memory 121, to an interconnect 120 of the SoC 100 as further elements of the functionally safe execution platform 110. For example, a flash memory unit 140, e.g., a NAND flash memory, may be connected to the interconnect 120 via an interface 141, and a random access memory unit 150, e.g., an LPDDR random-access memory, may be connected via a RAM controller 151. The SoC 100 may also comprise one or more further processor cores 130 with associated random-access and cache memory 131 which are connected to the interconnect 120. In addition, a memory unit 122, as a further element of the functionally safe execution platform 110 for a startup process (boot flash memory), and a peripheral bus 160 may be connected to the interconnect 120. A plurality of peripheral units, e.g., an analog-digital converter 161, a serial bus system 162 (serial peripheral interface, SPI), a direct memory access (DMA) unit 163, a timer 164, and a further field bus system 165, e.g., a Flexray field bus, may be connected to the peripheral bus 160. Of course, fewer or more peripheral units may be provided, indicated by reference sign 166. Via the serial bus system 162, for example an external monitoring unit 180 for detecting and managing an error or failure of the SoC 100 (watchdog) may be connected. In addition, the SoC 100 may have an error management module (EMM) 170 for managing error messages which are output.

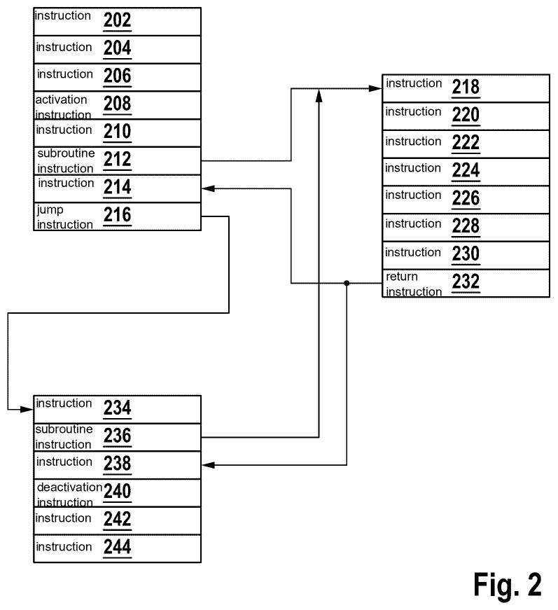

In the safe operating mode, the processor 111 calculates and checks check values of instructions which are read, to ensure integrity of the instructions from a compiler up to the processor core 111, as will be explained below with reference to FIGS. 2 to 8B.

FIGS. 2 to 8B schematically show respective embodiments of the method according to the present invention, in each case as a block diagram. The individual FIGS. 2 to 8B each show a sequence of instructions, which can be read and executed by the processor 111.

These individual instructions are generated, for example, in the course of a compiling process of program code by a compiler, wherein a reference check value of each generated instruction is calculated. These instructions, along with the respective reference check values, may, for example, be stored in the flash memory unit 140 and be copied from there into the random-access memory unit 150 during operation of the SoC 100. In particular, at least one of the instructions, expediently the first or the last of those which are to be executed safely, is stored together with the reference check value, for example as an argument of the instruction. However, preferably multiple instructions or all instructions are stored with their respective reference check values. The processor 111 may read the individual instructions, together with the respective reference check values, from the random-access memory 150, each in the course of an instruction fetch, and execute them.

As shown in FIG. 2, in the course of a regular operating mode, instructions 202, 204, and 206 are read and executed by the processor 111 in the regular manner. During this regular operating mode, no check value of the instructions which are read is calculated. When an activation instruction 208 is read, the processor 111 activates the safe operating mode. From then on, until the processor 111 deactivates the safe operating mode, for each instruction which is read a current check value is calculated from said instruction and the previous check value.

After the activation instruction 208 has been read, a first check value is calculated in particular from a first instruction currently to be executed and from a predetermined initial check value or a read initial check value as the previous check value. For example, the check value calculation may be initialized with a read initial check value such that a final value to be calculated later should, in an error-free case, correspond to a specified value, e.g., zero.

After the safe operating mode has been activated, the processor 111 reads an instruction 210 and calculates the current check value from this instruction 210 and the initial check value. The processor 111 then reads the next instruction 212 and calculates the current check value from this instruction 212 and from the previous check value.

This instruction 212 is, for example, a subroutine instruction for executing a subroutine. The processor 111 executes the corresponding subroutine or a corresponding program code module. In the course thereof, the processor 111 reads the instructions 218, 220, 222, 224, 226, 228, 230 and 232 and calculates in each case the current check value from the instruction which is read and the previous check value. The instruction 232 may be, for example, a return instruction which characterizes the end of the subroutine and instructs the processor 111 to return to the previous instruction sequence.

In response to the return instruction 232, the processor 111 reads the instructions 214 and 216 and calculates the current check value in each case. The instruction 216 may be, for example, a jump instruction for jumping to a particular instruction 234 or to its memory address in the random-access memory 150. The processor 111 then reads this instruction 234 and calculates the current check value. The next instruction 236 which is read may be, for example, a subroutine instruction again. Upon reading this subroutine instruction 236, the processor 111 re-reads the individual instructions 218, 220, 222, 224, 226, 228, 230, and 232 of this module and calculates the current check value in each case.

Upon re-reading the return instruction 232, processor 111 returns to the previous instruction sequence and reads the instructions 238 and 240 and calculates the current check value in each case.

The instruction 240 is, for example, a deactivation instruction for deactivating the safe operating mode. In response to this deactivation instruction 240 which has been read, the processor 111 deactivates the safe operating mode. The processor 111 also performs a check of the current check value upon reading the deactivation instruction 240. In the course thereof, it is checked whether the current check value calculated from the deactivation instruction 240, as a final value, corresponds, for example, to the specified value of zero.

If this final value does not correspond to the value of zero, this indicates an error and a specified action is performed, e.g., an error message is output or the system is stopped or put into a safe state. If, on the other hand, the final value corresponds to the value of zero, this indicates that there is no error. The processor 111 then returns to the regular operating mode. In the course thereof, the processor 111 reads the19nstructtions 242 and 244 without calculating a check value.

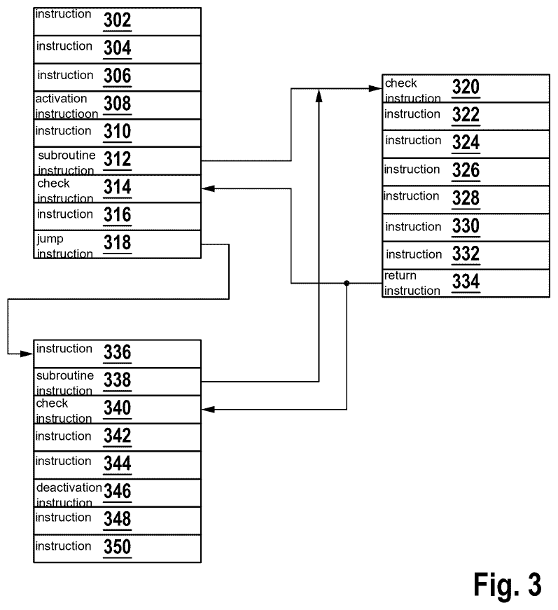

According to one embodiment, a check of the current check value may also be performed during the safe operating mode, as explained below with respect to FIG. 3. For example, if the subroutine is large or compiled from a different source file than the rest of the instructions, it may be expedient to check the check value at the start of this subroutine during the safe operating mode.

As shown in FIG. 3, in the course of the regular operating mode the processor 111 reads the instructions 302, 304, and 306 without calculating a check value. The next instruction 308 which is read is, for example, the activation instruction, whereupon the safe operating mode is activated. As explained above, from then on the processor 111 calculates the current check value from each instruction which is read and, in response to the activation instruction 306, initializes the check value calculation with an initial check value.

In the safe operating mode, the processor 111 first reads the instruction 310 and then the subroutine instruction 312, whereupon the subroutine is executed. In this subroutine, the processor 111 first reads a check instruction 320, whereupon the processor 111 performs a check of the presently current check value. In this way, the subroutine instruction 312 which has been read may be checked, in particular immediately after execution thereof. For this check, the processor 111 compares the check value calculated from the subroutine instruction 312 with, for example, the specified value of zero.

After this check, the processor 111 reads the next instruction 322 and calculates the current check value from this instruction 322 and the previous check value (here, zero).

The processor 111 then reads the instructions 324, 326, 328, 330, 332, and 334 of the subroutine and calculates the current check value in each case. The instruction 334 is, for example, a return instruction, whereupon the processor 111 returns to the previous instruction sequence and executes the instruction 314. This instruction 314 likewise is, for example, a check instruction, whereupon the processor 111 performs a check of the current check value again. In this way, the subroutine or its individual instructions can be checked, in particular immediately after their execution. Again, upon this check, the processor initializes the check value calculation with a new initial check value when the next instruction 316 is read.

The processor 111 then reads the instruction 318, this instruction 318 being, for example, a jump instruction, whereupon the processor 111 jumps to and reads the instruction 336. The processor 111 then reads the instruction 338, which is, for example, a subroutine instruction again. The processor 111 then reads the instruction 320 again, performs a check of the current check value, and re-initializes the check value calculation with the instruction 322. The processor 111 then reads the further instructions 324, 326, 328, 330, 332, and 334 of the subroutine again, returns to the previous instruction sequence in response to the return instruction 334, and reads the instruction 340. This instruction 340 likewise is a check instruction, in response to which the processor 111 performs a check of the current check value.

The processor 111 then reads the instructions 342, 344, and 346, the instruction 346 being the deactivation instruction and the safe operating mode being deactivated. Likewise in response to the deactivation instruction 346, the processor 111 performs a check of the current check value. The processor 111 then returns to the regular operating mode and reads the instructions 348 and 350 without calculating a check value.

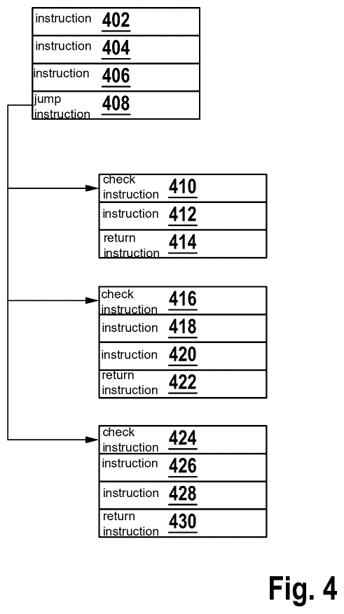

According to one embodiment, a check of the current check value may also be performed in the event of a jump instruction, as explained below with respect to FIG. 4. Since jump instructions may in principle also lead to a potentially hazardous target, it may be expedient to perform a check in the event of a jump.

In the example of FIG. 4, the processor 111 is already in the safe operating mode and, in the course thereof, reads the instructions 402, 404, 406 and 408 and calculates the current check value in each case. The instruction 408 is, for example, a jump instruction for performing an indirect jump to multiple addresses or to multiple further instructions 410, 416, and 424.

The processor 111 then reads each of these instructions 410, 416, and 424 and calculates the current check value in each case. In particular, each of these instructions 410, 416, and 424 is a check instruction, whereupon the processor 111 performs a check of the current check value in each case. In this way, the jump instruction 408 which has been read may be checked immediately after its execution. After the check in each case, the processor 111 reads the individual instructions 412, 414, 418, 420, 422, 426, 428, and 430 and calculates the current check value in each case.

For example, the instruction 408 may also be a subroutine instruction for executing multiple subroutines in the course of an indirect function call. In this case, the instructions 410, 412, and 414 characterize a first subroutine, the instructions 416, 418, 420, and 422 characterize a second subroutine, and the instructions 424, 426, 428, and 430 characterize a third subroutine. Furthermore, in this case the last instructions 414, 422, and 430 of the individual subroutines may each be a return instruction.

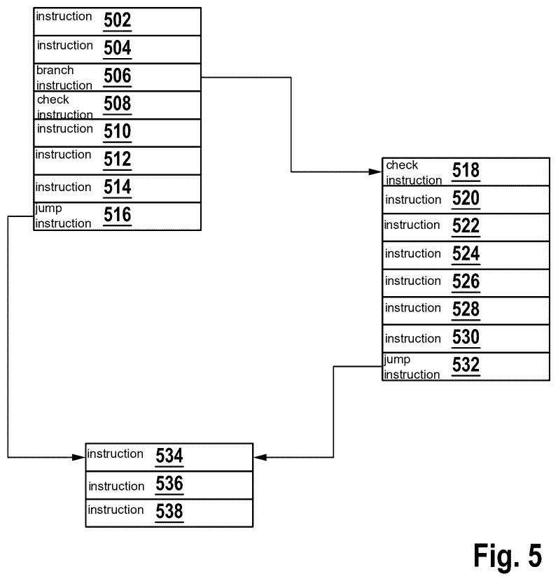

According to one embodiment, a check of the current check value may also be performed in the event of a branching instruction for executing multiple branches of instructions, as explained below with respect to FIG. 5.

Likewise in the example of FIG. 5, the processor 111 is already in the safe operating mode, in the course of which the processor 111 reads the instructions 502, 504 and 506 and calculates the current check value in each case. The instruction 506 is, for example, a branching instruction (e.g., if-then) for reading and executing the instructions 508, 510, 512, 514, and 516 as a first branch and for reading and executing the instructions 520, 522, 524, 526, 528, 530, and 532 as a second branch.

The processor 111 then reads the respective first instructions 508 and 518 of these two branches, these instructions 508 and 518 each being a check instruction, whereupon the processor 111 performs a check of the current check value in each case. The processor 111 then reads the remaining instructions of the two branches.

For example, the respective last instructions 516 and 532 of the two branches are, for example, each a jump instruction for jumping to the instruction 534. The two branches thus rejoin and the processor 111 reads this instruction 534 as well as the subsequent instructions 536 and 538.

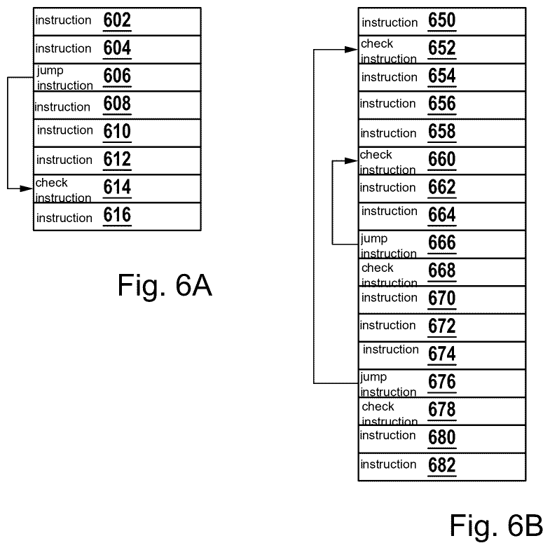

By means of jump or branching instructions, instructions in the instruction sequence may also be skipped or re-executed in the course of a loop, as explained below with respect to FIGS. 6A and 6B.

In the example of FIG. 6A, the processor 111 is already in the safe operating mode and reads the instructions 602, 604, and 606 and calculates the current check value in each case. The instruction 606 is a jump instruction for not executing the instructions 608, 610, and 612 and for jumping to the instruction 614. For example, the instruction 608 to be skipped may be a check instruction.

Upon reading the jump instruction 606, the processor 111 reads the instruction 614, which is, for example, a check instruction, and performs the corresponding check. The processor then proceeds with the instruction sequence and reads the instruction 616.

Likewise in the example of FIG. 6B, the processor 111 is in the safe operating mode, reads the instructions 650, 652, 654, 656, 658, 660, 662, 664, and 666, and calculates the current check value in each case. The instructions 652 and 660 are, for example, each a check instruction. The instruction 666 is a jump instruction for returning to the check instruction 660 and re-reading the instructions 660, 662, and 664. After this re-reading, the processor 111 reads the instructions 668, 670, 672, 674, and 676. The instruction 668 is, for example, likewise a check instruction. The instruction 676 is, for example, a jump instruction for returning to the check instruction 652 and re-reading the instructions 652 to 674. The processor 111 then proceeds with the instructions 678, 680, and 682, the instruction 678 likewise being a check instruction.

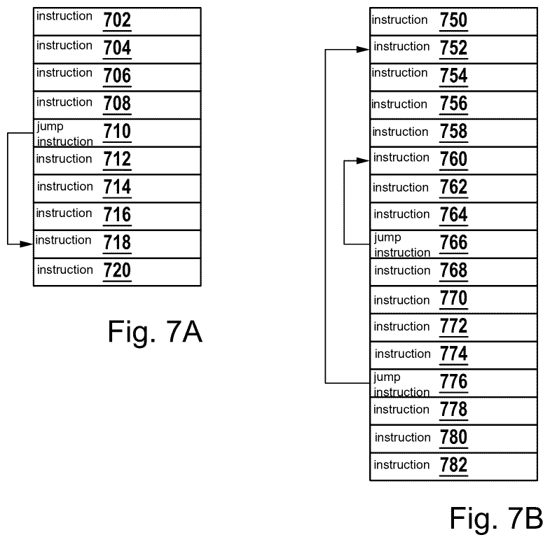

According to one embodiment, in such cases, if individual instructions are omitted or repeated, the current check value may also be modified using a modification instruction, as explained below with respect to FIGS. 7A and 7B.

In the example of FIG. 7A, the processor 111 is in the safe operating mode, reads the instructions 702, 704, 706, 708, and 710, and calculates the current check value in each case, the instruction 710 being a jump instruction for not executing the instructions 712, 714, and 716 and for jumping to the instruction 718. The instruction 704 is a first modification instruction that modifies the current check value as if the individual instructions 712, 714, and 716 not executed had nevertheless been executed.

Likewise in the example of FIG. 7B, the processor 111 is in the safe operating mode and reads the instructions 750, 752, 754, 756, 758, 760, 762, 764, and 766 and calculates the current check value in each case. The instruction 766 is a jump instruction for returning to the instruction 760 and re-reading the25nstructtions 760, 762, and 764. The instruction 758 is a second modification instruction that modifies the current check value as if the individual re-executed instructions 760, 762 and 764 had been executed only once.

After re-reading the instructions 760, 762, and 764, the processor 111 reads the instructions 768, 770, 772, 774, and 776. The instruction 776 is likewise a jump instruction for returning to the instruction 752 and re-reading the instructions 752 to 774. The instruction 770 likewise is a second modification instruction that modifies the current check value as if the individual re-executed instructions 752 to 774 had been executed only once.

After re-reading these instructions 752 to 774, the processor 111 proceeds with reading the next instructions 778, 780, and 782. For example, the instruction 780 likewise is a second modification instruction for modifying the current check value for a subsequent jump instruction.

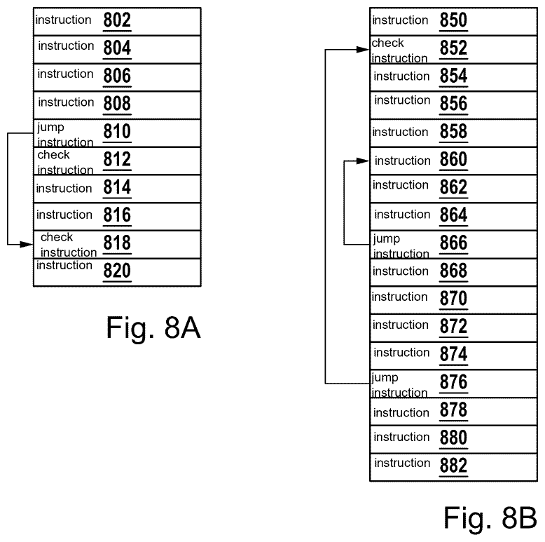

By using such first and second modification instructions, the number of check instructions can be reduced in comparison with FIGS. 6A and 6B. It is also possible to use a combination of modification and check instructions, as explained below with respect to FIGS. 8A and 8B.

In the example of FIG. 8A, the processor 111 is in the safe operating mode, reads the instructions 802, 804, 806, 808, and 810, and calculates the current check value in each case, the instruction 810 being a jump instruction for not executing the instructions 812, 814, and 816 and for jumping to the instruction 818. The instruction 804 is a modification instruction which, however, does not modify the current check value for the immediately next jump instruction 810. The instructions 812 and 818 may each be a check instruction.

Likewise in the example of FIG. 8B, the processor 111 is in the safe operating mode and reads the instructions 850, 852, 854, 856, 858, 860, 862, 864, and 866 and calculates the current check value in each case. The instruction 866 is a jump instruction for returning to the instruction 860 and re-reading the26nstructtions 860, 862, and 864. The instruction 852 is, for example, a check instruction. The instruction 858 is a second modification instruction that modifies the current check value as if the re-executed instructions 860, 862, and 864 had been executed only once.

After re-reading the instructions 860, 862, and 864, the processor 111 reads the instructions 868, 870, 872, 874, and 876, the instruction 876 being a jump instruction for returning to the check instruction 852. The processor 111 then re-reads the instructions 852 to 874 and subsequently proceeds with the instructions 878, 880, and 882.

1-12. (canceled)

13. A method for operating a computing unit in a safe operating mode, comprising:
reading an activation instruction for activating a safe operating mode, and activating the safe operating mode in response to the activation instruction which has been read;
in the safe operating mode, reading instructions and calculating a current check value for a current instruction to be executed and a previous check value; and
in the safe operating mode, checking the current check value at least once.

14. The method according to claim 13, further comprising:
in the safe operating mode, checking the current check value when a specified check event occurs.

15. The method according to claim 14, wherein the specified check event includes one or more of the following check events:
reading a specified check instruction;
reading a jump instruction for executing a jump;
reading a subroutine instruction for executing a subroutine;
reading a branching instruction for executing multiple branches of instructions.

16. The method according to claim 13, wherein a specified action is performed when no check of the current check value has been performed after a specified maximum number of instructions read and/or after a specified maximum time interval has elapsed.

17. The method according to claim 13, further comprising:
in the safe operating mode, reading a deactivation instruction for deactivating the safe operating mode;
calculating the current check value from the deactivation instruction and the previous check value;
checking the current check value.

18. The method according to claim 13, further comprising:
after the activation instruction has been read, calculating a first check value from a first instruction currently to be executed and from a predetermined initial check value or a read initial check value as the previous check value.

19. The method according to claim 13, further comprising, before the safe operating mode is activated:
providing a reference check value to instructions to be read.

20. The method according to claim 13, further comprising:
in the safe operating mode, when a number of instructions are not executed, reading a first modification instruction and modifying the current check value as if the individual instructions not executed had been executed; and/or
in the safe operating mode, when a number of already executed instructions are re-executed, reading a second modification instruction and modifying the current check value as if the individual re-executed instructions had been executed only once.

21. An apparatus, comprising:
a computing unit configured to operate in a safe operating mode, the computer unit configured to:
read an activation instruction for activating a safe operating mode, and activating the safe operating mode in response to the activation instruction which has been read;
in the safe operating mode, read instructions and calculate a current check value for a current instruction to be executed and a previous check value; and
in the safe operating mode, check the current check value at least once.

22. The apparatus according to claim 13, wherein the computing unit includes a processor unit based on a RISC-V instruction set architecture.

23. A non-transitory computer-readable storage medium on which is stored a computer program for operating a computing unit in a safe operating mode, the computer program, when executed by the computing unit, causing the computing unit to perform the following steps:
reading an activation instruction for activating a safe operating mode, and activating the safe operating mode in response to the activation instruction which has been read;
in the safe operating mode, reading instructions and calculating a current check value for a current instruction to be executed and a previous check value; and
in the safe operating mode, checking the current check value at least once.
